(19) United States
(12) Patent Application Publication
(10) Pub. No.: US 2006/0178282 A1
(43) Pub. Date: Aug. 10, 2006

(54) Process for production of etching or cleaning fluids

(76) Inventors: Makoto Suyama, Settsu-shi (JP); Takehiko Kezuka, Settsu-shi (JP); Mitsushi Itano, Settsu-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/549,181

(22) PCT Filed: Mar. 10, 2004
(86) PCT No.: PCT/JP04/03060

§ 371 Date: Sep. 16, 2005

(30) Foreign Application Priority Data
Mar. 17, 2003 (JP) 2003-071365

(51) Int. Cl. C11D 7/32

(52) U.S. Cl. 510/175

(57) ABSTRACT

A method for producing an etching or cleaning solution comprising (1) at least one member selected from the group consisting of fluoride salts and bifluoride salts formed from at least one member selected from the group consisting of ammonia, hydroxylamines, aliphatic amines, aromatic amines, aliphatic quaternary ammoniums and aromatic quaternary ammoniums with hydrofluoric acid; (2) at least one heteroatom-containing organic solvent; and (3) water, the method comprising the steps of: Step 1: mixing an aqueous hydrofluoric acid solution with at least one heteroatom-containing organic solvent, and Step 2: mixing the mixture obtained in Step 1 with at least one member selected from the group consisting of ammonia, hydroxylamines, aliphatic amines, aromatic amines, aliphatic quaternary ammoniums, aromatic quaternary ammoniums, and fluorides thereof.

### TECHNICAL FIELD

The present invention relates to a method for producing an etching or cleaning solution.

### BACKGROUND ART

Heretofore, a variety of products have been used as etching or cleaning compositions containing hydrofluorides and organic solvents (Japanese Unexamined Patent Publication Nos. 2000-164585 and 2000-164586 and Japanese Patent Application No. 2001-326948.

However, due to the poor solubility in organic solvents of salts of hydrofluoric acid with amines, or especially ammonia, it has been difficult to produce concentrated solutions which have, in particular, a low water content.

An object of the present invention is to provide a method for readily producing a solution for etching or cleaning.

### DISCLOSURE OF THE INVENTION

The present invention provides methods for producing an etching or cleaning solution as given below:
Item 1. A method for producing an etching or cleaning solution comprising (1) at least one member selected from the group consisting of fluoride salts and bifluoride salts formed from at least one member selected from the group consisting of ammonia, hydroxylamines, aliphatic amines, aromatic amines, aliphatic quaternary ammoniums and aromatic quaternary ammoniums with hydrofluoric acid; (2) at least one heteroatom-containing organic solvent; and (3) water,

the method comprising the steps of:
Step 1: mixing an aqueous hydrofluoric acid solution with at least one heteroatom-containing organic solvent, and
Step 2: mixing the mixture obtained in Step 1 with at least one member selected from the group consisting of ammonia, hydroxylamines, aliphatic amines, aromatic amines, aliphatic quaternary ammoniums, aromatic quaternary ammoniums, and fluorides thereof.
Item 2. A method for producing an etching or cleaning solution comprising (1) at least one member selected from the group consisting of fluoride salts and bifluoride salts formed from at least one member selected from the group consisting of ammonia, hydroxylamines, aliphatic amines, aromatic amines, aliphatic quaternary ammoniums and aromatic quaternary ammoniums with hydrofluoric acid; (2) at least one heteroatom-containing organic solvent; and (3) water,

the method comprising the steps of:
Step 1: mixing an aqueous hydrofluoric acid solution with at least one member selected from the group consisting of ammonia, hydroxylamines, aliphatic amines, aromatic amines, aliphatic quaternary ammoniums, aromatic quaternary ammoniums, and fluorides thereof,
Step 2: mixing the mixture obtained in Step 1 with at least one heteroatom-containing organic solvent, and, if necessary,
Step 3: subjecting the mixture obtained in Step 2 to filtration.
Item 3. A method for producing an etching or cleaning solution comprising (1) at least one member selected from the group consisting of fluoride salts and bifluoride salts formed from at least one member selected from the group consisting of ammonia, hydroxylamines, aliphatic amines, aromatic amines, aliphatic quaternary ammoniums and aromatic quaternary ammoniums with hydrofluoric acid; (2) at least one heteroatom-containing organic solvent; and (3) water,

the method comprising the step of dissolving solid matter of at least one member selected from the group consisting of fluoride salts and bifluoride salts formed from at least one member selected from the group consisting of ammonia, hydroxylamines, aliphatic amines, aromatic amines, aliphatic quaternary ammoniums and aromatic quaternary ammoniums in a mixed solution containing water and at least one heteroatom-containing organic solvent.
Item 4. The method according to Item 1 or 2, wherein the at least one member selected from the group consisting of ammonia, hydroxylamines, aliphatic amines, aromatic amines, aliphatic quaternary ammoniums, aromatic quaternary ammoniums, and fluorides thereof is in the form of an aqueous solution.
Item 5. The method according to Item 4, wherein the aqueous solution of the at least one member selected from the group consisting of ammonia, hydroxylamines, aliphatic amines, aromatic amines, aliphatic quaternary ammonium salts, aromatic quaternary ammonium salts, and fluorides thereof is an aqueous ammonium fluoride solution.
Item 6. The method according to Item 3, wherein the solid matter is ammonium bifluoride (NH₄F·HF).
Item 7. The method according to any one of Items 1 to 6, wherein the product solution is a water-containing solution comprising at least one member selected from the group consisting of ammonium bifluoride, mono-, di- or tri-ethanolamine bifluoride, and ethylamine bifluoride; and at least one heteroatom-containing organic solvent selected from the group consisting of ethanol, isopropanol (IPA), and acetone.
Item 8. The method according to any one of Items 1 to 7, wherein the product solution comprises the at least one member selected from the group consisting of ammonium bifluoride, monoethanolamine bifluoride, and ethylamine bifluoride in a proportion of 0.001 to 5 mass. %; the at least one heteroatom-containing organic solvent selected from the group consisting of ethanol, isopropanol (IPA), and acetone in a proportion of 92 to 99.9989 mass. %; and water in a proportion of 0.0001 to 3 mass. %.
Item 9. A method for producing an etching or cleaning composition comprising ammonium bifluoride and a heteroatom-containing organic solvent,

the method comprising the steps of mixing a heteroatom-containing organic solvent with an aqueous hydrofluoric acid solution, and then adding an ammonium fluoride solution thereto.
Item 10. A method for producing an etching or cleaning solution comprising ammonium bifluoride and a heteroatom-containing organic solvent,

the method comprising the steps of mixing a heteroatom-containing organic solvent with a mixed solution in which an aqueous hydrofluoric acid solution and an ammonium fluoride solution have been mixed, and filtering off precipitated ammonium bifluoride.

Solutions obtained according to the methods of the present invention are advantageously usable as etching or cleaning solutions.

Such etching solutions are advantageously usable in place of the etching solutions disclosed in Japanese Unexamined Patent Publication. Nos. 2000-164585 and 2000-164586. Japanese Unexamined Patent Publication. Nos. 2000-164585 and 2000-164586 are incorporated herein by reference.

Such cleaning solutions are advantageously usable in the semiconductor production processes, and in particular, are usable as cleaning agents that do not cause surface roughness when cleaning STIs, metal gates, contact holes, via holes, capacitors, etc.; and removing polymers attributable to resist and post-CMP cleaning. Such cleaning agents are advantageously usable in the production of liquid crystal panel elements, and ICs, LSIs and like semiconductor elements.

It is a feature of the solutions produced according to the method of the invention to comprise (1) at least one member selected from the group consisting of fluoride salts and bifluoride salts formed from at least one member selected from the group consisting of ammonia, hydroxylamines, aliphatic amines, aromatic amines, aliphatic quaternary ammoniums and aromatic quaternary ammoniums (hereinafter referred to as “nitrogen-containing basic components”) with hydrofluoric acid; (2) at least one heteroatom-containing organic solvent; and (3) water.

(1) Nitrogen-Containing Basic Components

Examples of nitrogen-containing basic components are ammonia, hydroxylamines, aliphatic amines, aromatic amines, aliphatic quaternary ammoniums, and aromatic quaternary ammoniums.

Examples of hydroxylamines are N,N-dimethylhydroxylamine, N-ethylhydroxylamine, N,N-diethylhydroxylamine, N-propylhydroxylamine, N-phenylhydroxylamine, and like hydroxylamines that are mono- or disubstituted with linear or branched C₁₋₄ alkyl groups or phenyl groups.

Examples of aliphatic amines are ethylamine, propylamine, isopropylamine, butylamine, hexylamine, octylamine, decylamine, dodecylamine, dimethylamine, diethylamine, dipropylamine, diisopropylamine, dibutylamine, trimethylamine, triethylamine, tripropylamine, triisopropylamine, tributylamine, and like aliphatic amines that are mono-, di- or trisubstituted with linear or branched C₁₋₁₂ alkyl groups; monofluoromethylamine, difluoromethylamine, trifluoromethylamine, perfluoroethylamine, perfluoropropylamine, perfluoroisopropylamine, perfluorobutylamine, perfluorohexylamine, perfluorooctylamine, di(perfluoromethyl)amine, di(perfluoroethyl)amine, di(perfluoropropyl)amine, di(perfluoroisopropyl)amine, di(perfluorobutyl)amine, tri(perfluoromethyl)amine, tri(perfluoroethyl)amine, tri(perfluoropropyl)amine, tri(perfluoroisopropyl)amine, tri(perfluorobutyl)amine, and like aliphatic amines that are mono-, di- or trisubstituted with at least one linear or branched fluorine-containing C₁₋₈ alkyl group; ethanolamine, ethylenediamine, 2-(2-aminoethylamino)ethanol, diethanolamine, 2-ethylaminoethanol, dimethylaminoethanol, ethyldiethanolamine, cyclohexylamine, dicyclohexylamine, etc.

Examples of aromatic amines are aniline, N-methylaniline, N,N-dimethylaniline, benzylamine, dibenzylamine, N-methylbenzylamine, etc.

Examples of aliphatic quaternary ammoniums and aromatic quaternary ammoniums are chlorides, bromides, sulfates, nitrates, and like mineral acid salts of tetraethylammonium, tetrapropylammonium, tetraisopropylammonium, tetrabutylammonium, tetraphenylammonium, and like aliphatic and aromatic quaternary ammoniums.

Such nitrogen-containing basic components can be used singly or as a combination of two or more types.

(2) Fluoride Salts and Bifluoride Salts Formed from Nitrogen-Containing Basic Components and Hydrofluoric Acid

Fluoride salts formed from nitrogen-containing basic components and hydrofluoric acid refer to compounds in which a nitrogen-containing basic component and hydrofluoric acid (HF) are compounded in a molar ratio of 1:1. For example, a fluoride formed from ammonia and hydrofluoric acid is ammonium fluoride. Similarly, from hydroxylamines, aliphatic amines and aromatic amines used in conjunction with hydrofluoric acid, fluorides are formed in which the respective ingredients are compounded with hydrofluoric acid in a ratio of 1:1 [(nitrogen-containing basic component)·HF].

Fluorides formed from aliphatic or aromatic quaternary ammonium and hydrofluoric acid can be represented as (aliphatic or aromatic quaternary ammonium) HF.

Likewise, bifluoride salts formed from nitrogen-containing basic components and hydrofluoric acid refer to compounds in which a nitrogen-containing basic component and hydrofluoric acid (HF) are compounded in a molar ratio of 1:2. For example, a bifluoride salt formed from ammonia and hydrofluoric acid is ammonium bifluoride. Similarly, from hydroxylamines, aliphatic amines and aromatic amines used in conjunction with hydrofluoric acid, bifluorides are formed in which the respective ingredients are compounded with hydrofluoric acid in a ratio of 1:2 [(nitrogen-containing basic component)·2HF].

Bifluoride salts formed from aliphatic or aromatic quaternary ammonium and hydrofluoric acid can be represented as (aliphatic or aromatic quaternary ammonium)F·HF.

According to the method of the invention, a solution containing a bifluoride with markedly poor water miscibility can be advantageously produced.

Examples of fluoride salts and bifluoride salts preferably usable in the invention are ammonium fluoride, ammonium bifluoride, monoethanolamine fluoride, monoethanolamine bifluoride, ethylamine fluoride, ethylamine bifluoride, diethanolamine fluoride, diethanolamine bifluoride, triethanolamine fluoride, triethanolamine bifluoride, methylamine fluoride, methylamine bifluoride, propylamine fluoride, propylamine bifluoride, etc. Particularly preferable are fluoride salts and bifluoride salts of ammonia, monoethanolamine, and ethylamine.

(3) Heteroatom-Containing Organic Solvents

Examples of heteroatom-containing organic solvents usable in the composition of the invention are N,N-dimethylformamide, N,N-dimethylacetamide, dimethylsulfoxide, N-methyl-2-pyrrolidone, 1,3-dimethyl-2-imidazolidinone; methanol, ethanol, isopropanol (IPA), 1-propanol, 1-butanol, 2-butanol, t-butanol, 2-methyl-l-propanol, 1-pentanol, 1-hexanol, 1-heptanol, 4-heptanol, 1-octanol, 1-nonanol, 1-decanol, 1-dodecanol, and like alcohols; ethylene glycol, 1,2-propanediol, propylene glycol, 2,3-butanediol, glycerol, and like polyols; acetone, acetylacetone, methyl ethyl ketone, 1,3-dihydroxyacetone, and like ketones; acetonitrile, propionitrile, butyronitrile, isobutyronitrile, benzonitrile, and like nitriles; formaldehyde, acetaldehyde, propionaldehyde, and like aldehydes; ethylene glycol monomethyl ether, ethylene glycol monoethyl ether, diethylene glycol monobutyl ether, and like alkylene glycol monoalkyl ethers; tetrahydrofuran, dioxane, and like cyclic ethers; trifluoroethanol, pentafluoropropanol, 2,2,3,3-tetrafluoropropanol, and like fluoroalcohols; 1,1,2,2-tetrafluoro-1-(2,2,2-trifluoroethoxy)ethane, and like hydrofluoroethers; acetic acid, propionic acid, butyric acid, isobutyric acid, valeric acid, caproic acid, caprylic acid, monochloroacetic acid, dichloroacetic acid, trichloroacetic acid, monofluoroacetic acid, difluoroacetic acid, trifluoroacetic acid, α-chlorobutyric acid, δ-chlorobutyric acid, γ-chlorobutyric acid, lactic acid, glycolic acid, pyruvic acid, glyoxalic acid, acrylic acid, and like monocarboxylic acids; methanesulfonic acid, toluenesulfonic acid, and like sulfonic acids; oxalic acid, succinic acid, adipic acid, tartaric acid, citric acid, and like polycarboxylic acids; sulfolane; and nitromethane. Particularly preferable are alcohols, monocarboxylic acids, ketones, and like oxygen-containing organic solvents. Specific examples thereof are methanol, ethanol, n-propanol, isopropanol (IPA), and like alcohols; acetone, methyl ethyl ketone, 1,3-dihydroxyacetone, and like ketones; and acetic acid, propionic acid, and like monocarboxylic acids. Such heteroatom-containing organic solvents can be used singly or as a combination of two or more types.

(4) Production Method of the Invention

Hereinbelow, fluoride salts formed from nitrogen-containing basic components and hydrofluoric acid are sometimes simply referred to as fluorides. Bifluoride salts formed from nitrogen-containing basic components and hydrofluoric acid are sometimes simply referred to as bifluorides.

Hydrofluoric acid is preferably used in the form of an aqueous solution containing hydrogen fluoride in a proportion of 55 mass. % or less, and particularly preferably about 50 mass. %.

Fluorides and bifluorides exhibit poor solubility in heteroatom-containing organic solvents. For example, even when an aqueous hydrofluoric acid solution is added after introducing an aqueous solution of a fluoride into a heteroatom-containing organic solvent, a precipitate forms, and this precipitate remains undissolved.

When solid matter of a fluoride or bifluoride is used, it needs to be introduced into water or an water-containing organic solvent. When solid matter of a fluoride or bifluoride is first introduced into a nonaqueous organic solvent and then mixed with water, the solid matter of the fluoride or bifluoride does not dissolve.

With respect to the present invention the order of mixing the ingredients is therefore very important.

One embodiment of the method for producing a solution containing a bifluoride as a principal ingredient is first mixing a heteroatom-containing organic solvent with an aqueous hydrofluoric acid solution, and then introducing a nitrogen-containing basic component or an aqueous solution of a fluoride thereof. When this order of addition is altered to first mixing a heteroatom-containing organic solvent with a nitrogen-containing basic component or an aqueous solution of a fluoride thereof, and then introducing an aqueous hydrofluoric acid solution, precipitation occurs without dissolution.

One embodiment of the method for producing a solution containing a fluoride as a principal ingredient is first mixing a heteroatom-containing organic solvent with an aqueous hydrofluoric acid solution, and then introducing a nitrogen-containing basic component or an aqueous solution thereof. When this order of addition is altered to first mixing a heteroatom-containing organic solvent with a nitrogen-containing basic component or an aqueous solution thereof, and then introducing an aqueous hydrofluoric acid solution precipitation occurs.

Another embodiment of the method for producing a solution containing a bifluoride is mixing an aqueous hydrofluoric acid solution with an aqueous solution of a fluoride, preferably in an HF/fluoride molar ratio of 1:1, to create an aqueous solution of a bifluoride, and then mixing this aqueous solution with a heteroatom-containing organic solvent. In this embodiment, as the amount of organic solvent is relatively reduced, a concentrated bifluoride solution is obtained, and depending on the concentration, the bifluoride precipitates. This precipitate is a pure bifluoride and thus is advantageously usable in applications in which a bifluoride of high purity is required, for example, in semiconductor production. A filtrate is advantageously usable as a solution for etching or cleaning. Such a filtrate is a bifluoride solution of high concentration and so may be mixed with a heteroatom-containing organic solvent to tailor the concentration for use. Since it takes water-containing solutions of bifluorides such as NH₄F·HF a long period of time to reach equilibrium, bifluorides tend to precipitate before full saturation is reached. The concentration of bifluoride in a filtrate can be determined by measuring electrical conductivity. Such a solution can be tailored to a desired concentration by dilution or the like.

Another embodiment of the method for producing a solution containing a fluoride is mixing an aqueous hydrofluoric acid solution with a nitrogen-containing basic component or an aqueous solution thereof, preferably in an HF/nitrogen-containing basic component molar ratio of 1:1, to create an aqueous solution of a fluoride, and then mixing this aqueous solution with a heteroatom-containing organic solvent. In this embodiment, as the amount of organic solvent is relatively reduced, a concentrated fluoride solution is obtained, and depending on the concentration, the fluoride precipitates. This precipitate is a pure fluoride and thus is advantageously usable in applications in which a fluoride of high purity is required, for example, in semiconductor production. A filtrate thereof is advantageously usable as a solution for etching or cleaning. Such a filtrate is a fluoride solution of high concentration and so may be mixed with a heteroatom-containing organic solvent to tailor the concentration for use. Since it takes water-containing solutions of fluorides such as NH₄F a long period of time to reach equilibrium, fluorides tend to precipitate before full saturation is reached. The concentration of fluoride in a filtered solution can be determined by measuring electrical conductivity. Such a solution can be tailored to a desired concentration by dilution or the like.

Another embodiment of the method for producing a solution containing a bifluoride is introducing solid matter of a bifluoride into a water-containing solution for dissolution, in which a heteroatom-containing organic solvent and water have been mixed. With respect to this embodiment, the bifluoride does not completely dissolve even when water is added after introducing the bifluoride into a heteroatom-containing organic solvent. Therefore, it is necessary to first introduce the bifluoride into the water-containing organic solvent.

Another embodiment of the method for producing a solution containing a fluoride is introducing solid matter of a fluoride into a water-containing solution for dissolution, in which a heteroatom-containing organic solvent and water have been mixed. With respect to this embodiment, the fluoride does not completely dissolve even when water is added after introducing the fluoride into a heteroatom-containing organic solvent. Therefore, it is necessary to first introduce the fluoride into the water-containing organic solvent.

In solutions for etching or cleaning obtained according to the method of the invention, the proportion of nitrogen-containing basic component bifluorides, such as ammonium bifluoride, is preferably about 0.001 to about 10 mass. %, and more preferably about 0.001 to about 5 mass. %. The proportion of nitrogen-containing basic component fluorides, such as ammonium fluoride, is preferably about 0.001 to about 10 mass. %, more preferably about 0.001 to about 5 mass. %, and particularly preferably about 0.001 to about 4 mass. %.

The proportion of water is preferably up to 10 mass. % and more preferably up to 3 mass. %, and preferably at least 0.0001 mass. % and more preferably at least 0.0005 mass. %.

The proportion of heteroatom-containing organic solvent is preferably 80 mass. % or greater, and more preferably 92 mass. % or greater.

Solutions produced according to the method of the invention usually contain (1) 0.001 to 10 mass. % of the at least one member selected from the group consisting of fluorides and bifluorides, (2) 80 to 99.9989 mass. % of heteroatom-containing organic solvent, and (3) 0.0001 to 10 mass. % of water; and preferably (1) 0.001 to 5 mass. % of the at least one member selected from the group consisting of fluorides and bifluorides, (2) 85 to 99.9985 mass. % of heteroatom-containing organic solvent, and (3) 0.0005 to 10 mass. % of water.

Preferable ratios of components of the solution of the present invention are given below:

ammonium bifluoride: IPA: water=0.001-5 mass. %: 92-99.999 mass. %: from more than 0 to 3 mass. %; preferably 0.001-5 mass. %: 92-99.9989 mass. %: 0.0001-3 mass. %; and more preferably 0.001-5 mass. %: 92-99.9985 mass. %: 0.0005-3 mass. %

ammonium bifluoride: ethanol: water=0.001-5 mass. %: 92-99.999 mass. %: from more than 0 to 3 mass. %; preferably 0.001-5 mass. %: 92-99.9989 mass. %: 0.0001-3 mass. %; and more preferably 0.001-5 mass. %: 92-99.9985 mass. %: 0.0005-3 mass. %

ammonium bifluoride: acetone: water=0.001-5 mass. %: 92-99.999 mass. %: from more than 0 to 3 mass. %; preferably 0.001-5 mass. %: 92-99.9989 mass. %: 0.0001-3 mass. %; and more preferably 0.001-5 mass. %: 92-99.9985 mass. %: 0.0005-3 mass. %

ammonium fluoride: IPA: water=0.001-4 mass. %: 86-99.999 mass. %: from more than 0 to 10 mass. %; preferably 0.001-4 mass. %: 86-99.9989 mass. %: 0.0001-10 mass. %; and more preferably 0.001-4 mass. %: 86-99.9985 mass. %: 0.0005-10 mass. %

ammonium fluoride: acetic acid: water=0.001-4 mass. %: 94.5-99.999 mass. %: from more than 0 to 1.5 mass. %; preferably 0.001-4 mass. %: 94.5-99.9989 mass. %: 0.0001-1.5 mass. %; and more preferably 0.001-4 mass. %: 94.5-99.9985 mass. %: 0.0005-1.5 mass. %

ammonium fluoride: ethanol: water=0.001-5 mass. %: 85-99.999 mass. %: from more than 0 to 10 mass. %; preferably 0.001-5 mass. %: 85-99.9989 mass. %: 0.0001-10 mass. %; and more preferably 0.001-5 mass. %: 85-99.9985 mass. %: 0.0005-10 mass. %

monoethanolamine bifluoride: ethanol: water=0.001-5 mass. %: 92-99.999 mass. %: from more than 0 to 3 mass. %; preferably 0.001-5 mass. %: 92-99.9989 mass. %: 0.0001-3 mass. %; and more preferably 0.001-5 mass. %: 92-99.9985 mass. %: 0.0005-3 mass. %

monoethanolamine bifluoride: IPA: water=0.001-5 mass. %: 92-99.999 mass. %: from more than 0 to 3 mass. %; preferably 0.001-5 mass. %: 92-99.9989 mass. %: 0.0001-3 mass. %; and more preferably 0.001-5 mass. %: 92-99.9985 mass. %: 0.0005-3 mass. %

Due to their superior storage stability, solutions for etching or cleaning obtained according to the method of the invention can be used after storage once produced in large amounts; the solution may also be produced in an amount just sufficient for immediate use in a factory or like facility where etching or cleaning is conducted. Moreover, the solution can be produced as a solution with a high fluoride or bifluoride concentration, and diluted for use to a desired concentration by adding a heteroatom-containing solvent.

According to the present invention, solutions for etching or cleaning can be readily produced.

### BEST MODE FOR CARRYING OUT THE INVENTION

Examples and Comparative Examples are given below to illustrate the invention in more detail.

In the Examples, the state of crystal precipitation was visually inspected.

Electric conductivities are given as values (uS/cm) measured at 25° C. using a CM-40S manufactured by Toa Electronics.

### EXAMPLES 1 AND 2 AND COMPARATIVE EXAMPLES 1 AND 2

Table 1 shows the state of crystal precipitation and the electrical conductivity of the resulting etching solutions according to the order of addition of 50% HF (HF: 0.0067 mol) and 40% NH₄F (NH₄F: 0.0067 mol) to 1 l of an organic solvent (IPA).

Addition to IPA was carried out in the following manner.

While stirring 1 l of an organic solvent (IPA), a 50% aqueous HF solution was gradually added dropwise, and then a 40% aqueous NH₄F solution was gradually added dropwise.

TABLE 1
Result of preparing etching solutions by altering the order of
addition of 50% HF and 40% NH₄F

| | Order of adding | Organic | Amount of | Amount of | | Electrical |
|---|---|---|---|---|---|---|
| | 50% HF/40% | solvent | 50% HF | 40% NH₄F | | conductivity |
| | NH₄F | (ml) | (g) | (g) | Solubility | μS/cm |
| Ex. 1 | 50% HF added first | IPA | 0.268 | 0.620 | Completely | 20.1 |
| | and then 40% | 1000 | | | dissolved | |
| | NH₄F added | | | | | |
| Ex. 2 | 50% HF added first | IPA | 0.372 | 0.861 | Completely | 29.0 |
| | and then 40% | 1000 | | | dissolved | |
| | NH₄F added | | | | | |
| Comp. | 40% NH₄F added | IPA | 0.268 | 0.620 | Crystals | 13.2 |
| Ex. 1 | first and then 50% | 1000 | | | precipitated | |
| | HF added | | | | | |
| Comp. | 40% NH₄F added | IPA | 0.372 | 0.861 | Crystals | 17.0 |
| Ex. 2 | first and then 50% | 1000 | | | precipitated | |
| | HF added | | | | | |

### EXAMPLE 3 TO 5

A 50% aqueous HF solution (32.0 g) and a 40% aqueous NH₄F solution (73.6 g) were mixed to prepare an equimolar solution of NH₄F and HF.

One liter of an organic solvent (IPA) and the entire equimolar NH₄F/HF solution prepared above were mixed. Although NH₄F/HF did not completely dissolve in the IPA and crystals precipitated, stirring was performed for dissolution until the electrical conductivity of the supernatant liquid reached 400 μS/cm.

Once the electrical conductivity of the supernatant liquid reached 400 μS/cm or greater, the supernatant liquid and the crystalline portion were separated by filtration.

IPA and the supernatant liquid were admixed while monitoring the electrical conductivity to control the concentration of the etching solution. Results are shown in Table 2.

TABLE 2
Result of preparing etching solutions using high concentration
NH₄F.HF/IPA supernatant liquid

| | Electrical conductivity of high concentration | | | |
|---|---|---|---|---|
| | NH₄F.HF/IPA supernatant liquid | | | |
| | 480 (μS/cm) | | | |
| | | Amount of | | |
| | | high concentration | | |
| | | NH₄F.HF/IPA | Electrical | |
| | Solvent | supernatant | conductivity | |
| | (ml) | liquid (g) | (μS/cm) | Solubility |
| Ex. 3 | IPA 1000 | 53.0 | 26.3 | Completely |
| | | | | dissolved |
| Ex. 4 | IPA 1000 | 63.0 | 30.6 | Completely |
| | | | | dissolved |
| Ex. 5 | IPA 1000 | 74.0 | 34.9 | Completely |
| | | | | dissolved |

### EXAMPLE 6 AND COMPARATIVE EXAMPLE 3

Table 3 shows the state of crystal precipitation and the electrical conductivity of the resulting etching solutions according to the order of addition of powdery NH₄F—HF and water to 1 l of an organic solvent (IPA). 50% HF (HF: 0.0067 mol) and 40% NH₄F (NH₄F: 0.0067 mol) to 1 l of an organic solvent (IPA) .

To 1 l of an organic solvent (IPA) was added 5.0 g of water with stirring, and then 0.38 g of powdery NH₄F·HF was added thereto and sufficiently stirred.

Likewise, to 1 l of an organic solvent (IPA) was added 0.38 g of powdery NH₄F·HF with stirring, and then 5.0 g of water was added thereto and sufficiently stirred.

TABLE 3
Result of preparing etching solutions by altering the order of
adding powdery NH₄F.HF and water

| | Order of adding | Organic | Amount of | Amount of | | Electrical |
|---|---|---|---|---|---|---|
| | powdery NH₄F.HF | solvent | NH₄F.HF | water | | conductivity |
| | and water | (ml) | (g) | (g) | Solubility | (μS/cm) |
| Ex. 6 | Water added first | IPA | 0.38 | 5.0 | Completely | 20.1 |
| | and then powdery | 1000 | | | dissolved | |
| | NH₄F.HF added | | | | | |
| Comp. | Powdery NH₄F.HF | IPA | 0.38 | 5.0 | Crystals | 7.3 |
| Ex. 2 | added first and then | 1000 | | | precipitated | |
| | water added | | | | | |

1. A method for producing an etching or cleaning solution comprising (1) at least one member selected from the group consisting of fluoride salts and bifluoride salts formed from at least one member selected from the group consisting of ammonia, hydroxylamines, aliphatic amines, aromatic amines, aliphatic quaternary ammoniums and aromatic quaternary ammoniums with hydrofluoric acid; (2) at least one heteroatom-containing organic solvent; and (3) water,
the method comprising the steps of:
Step 1: mixing an aqueous hydrofluoric acid solution with at least one heteroatom-containing organic solvent, and
Step 2: mixing the mixture obtained in Step 1 with at least one member selected from the group consisting of ammonia, hydroxylamines, aliphatic amines, aromatic amines, aliphatic quaternary arnmoniums, aromatic quaternary ammoniums, and fluorides thereof.

2. A method for producing an etching or cleaning solution comprising (1) at least one member selected from the group consisting of fluoride salts and bifluoride salts formed from at least one member selected from the group consisting of ammonia, hydroxylamines, aliphatic amines, aromatic amines, aliphatic quaternary ammoniums and aromatic quaternary ammoniums with hydrofluoric acid; (2) at least one heteroatom-containing organic solvent; and (3) water,
the method comprising the steps of:
Step 1: mixing an aqueous hydrofluoric acid solution with at least one member selected from the group consisting of ammonia, hydroxylamines, aliphatic amines, aromatic amines, aliphatic quaternary ammoniums, aromatic quaternary ammoniums, and fluorides thereof,
Step 2: mixing the mixture obtained in Step 1 with at least one heteroatom-containing organic solvent, and, if necessary,
Step 3: subjecting the mixture obtained in Step 2 to filtration.

3. A method for producing an etching or cleaning solution comprising (1) at least one member selected from the group consisting of fluoride salts and bifluoride salts formed from at least one member selected from the group consisting of ammonia, hydroxylamines, aliphatic amines, aromatic amines, aliphatic quaternary ammoniums, and aromatic quaternary ammoniums with hydrofluoric acid; (2) at least one heteroatom-containing organic solvent; and (3) water,
the method comprising the step of dissolving solid matter of at least one member selected from the group consisting of fluoride salts and bifluoride salts formed from at least one member selected from the group consisting of ammonia, hydroxylamines, aliphatic amines, aromatic amines, aliphatic quaternary ammoniums and aromatic quaternary ammoniums in a mixed solution containing water and at least one heteroatom-containing organic solvent.

4. The method according to claim 1, wherein the at least one member selected from the group consisting of ammonia, hydroxylamines, aliphatic amines, aromatic amines, aliphatic quaternary ammoniums, aromatic quaternary ammoniums, and fluorides thereof is in the form of an aqueous solution.

5. The method according to claim 4, wherein the aqueous solution of the at least one member selected from the group consisting of ammonia, hydroxylamines, aliphatic amines, aromatic amines, aliphatic quaternary ammoniums, aromatic quaternary ammoniums, and fluorides thereof is an aqueous ammonium fluoride solution.

6. The method according to claim 3, wherein the solid matter is ammonium bifluoride (NH₄F·HF).

7. The method according to claim 1, wherein the product solution is a water-containing solution comprising at least one member selected from the group consisting of ammonium bifluoride, mono-, di- or tri-ethanolamine bifluoride, and ethylamine bifluoride; and at least one heteroatom-containing organic solvent selected from the group consisting of ethanol, isopropanol (IPA), and acetone.

8. The method according to claim 1, wherein the product solution comprises the at least one member selected from the group consisting of ammonium bifluoride, monoethanolamine bifluoride, and ethylamine bifluoride in a proportion of 0.001 to 5 mass. %; the at least one heteroatom-containing organic solvent selected from the group consisting of ethanol, isopropanol (IPA), and acetone in a proportion of 92 to 99.9989 mass. %; and water in a proportion of 0.0001 to 3 mass. %.

9. A method for producing an etching or cleaning composition comprising ammonium bifluoride and a heteroatom-containing organic solvent,
the method comprising the steps of mixing a heteroatom-containing organic solvent with an aqueous hydrofluoric acid solution, and then adding an ammonium fluoride solution thereto.

10. A method for producing an etching or cleaning solution comprising ammonium bifluoride and a heteroatom-containing organic solvent,
the method comprising the steps of mixing a heteroatom-containing organic solvent with a mixed solution in which an aqueous hydrofluoric acid solution and an ammonium fluoride solution have been mixed, and filtering off precipitated ammonium bifluoride.

11. The method according to claim 2, wherein the at least one member selected from the group consisting of ammonia, hydroxylamines, aliphatic amines, aromatic amines, aliphatic quaternary ammoniums, aromatic quaternary ammoniums, and fluorides thereof is in the form of an aqueous solution

12. The method according to claim 11, wherein the aqueous solution of the at least one member selected from the group consisting of ammonia, hydroxylamines, aliphatic amines, aromatic amines, aliphatic quaternary ammoniums, aromatic quaternary ammoniums, and fluorides thereof is an aqueous ammonium fluoride solution.

13. The method according to claim 2, wherein the product solution is a water-containing solution comprising at least one member selected from the group consisting of ammonium bifluoride, mono-, di- or tri-ethanolamine bifluoride, and ethylamine bifluoride; and at least one heteroatom-containing organic solvent selected from the group consisting of ethanol, isopropanol (IPA), and acetone.

14. The method according to claim 3, wherein the product solution is a water-containing solution comprising at least one member selected from the group consisting of ammonium bifluoride, mono-, di- or tri-ethanolamine bifluoride, and ethylamine bifluoride; and at least one heteroatom-containing organic solvent selected from the group consisting of ethanol, isopropanol (IPA), and acetone.

15. The method according to claim 2, wherein the product solution comprises the at least one member selected from the group consisting of ammonium bifluoride, monoethanolamine bifluoride, and ethylamine bifluoride in a proportion of 0.001 to 5 mass. %; the at least one heteroatom-containing organic solvent selected from the group consisting of ethanol, isopropanol (IPA), and acetone in a proportion of 92 to 99.9989 mass. %; and water in a proportion of 0.0001 to 3 mass. %.

16. The method according to claim 3, wherein the product solution comprises the at least one member selected from the group consisting of ammonium bifluoride, monoethanolamine bifluoride, and ethylamine bifluoride in a proportion of 0.001 to 5 mass. %; the at least one heteroatom-containing organic solvent selected from the group consisting of ethanol, isopropanol (IPA), and acetone in a proportion of 92 to 99.9989 mass. %; and water in a proportion of 0.0001 to 3 mass. %.Z
